(19) United States
(12) Patent Application Publication
(10) Pub. No.: US 2004/0243600 A1
(43) Pub. Date: Dec. 2, 2004

(54) Information processing device, information processing device control method, and computer-readable medium

(75) Inventors: Hirokazu Ikeda, Yamoto (JP); Toshiaki Hirata, Kashiwa (JP); Yusuke Izumida, Chigasaki (JP); Masahide Sato, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/805,023

(22) Filed: Mar. 18, 2004

(30) Foreign Application Priority Data
Mar. 20, 2003 (JP) 2003-079166
Oct. 30, 2003 (JP) 2003-369814

(51) Int. Cl. G06F 17/00

(52) U.S. Cl. 707/100

(57) ABSTRACT

The present invention relates to a program that performs the step of allowing an information processing device included in an information processing system to receive a parameter entered for setting policies in which processes to be performed in the information processing system are defined, and the step of changing the parameter for the policies so that a policy set, which is an aggregate of policies set by the parameter, better matches the control strategy of the information processing system.

### CROSS-REFERENCE TO RELATED APPLICATIONS

The present application claims priority upon Japanese Patent Application No. 2003-79166 filed on Mar. 20, 2003 and Japanese Patent Application No. 2003-369814 filed on Oct. 30, 2003, which are herein incorporated by reference.

### BACKGROUND OF THE INVENTION

1. Field of the Invention

The present invention relates to a program, an information processing device, an information processing device control method, and recording medium.

2. Description of the Related Art

In recent years, the information technology has advanced so that the employed information processing system is highly advanced and enlarged in size. Accordingly, the volume of system management work is increased and the system management operations are complicated and advanced.

The technology disclosed in Japanese Patent Application Laid-open Publication No. 2000-244495 defines the management operations as a policy to facilitate the management of the information processing system for the purpose of reducing the management load on the information processing system.

The conventional technology can reduce the system management operation load by setting policies for individual management targets within the system. However, it cannot detect incorrect policy settings or discrepancies and inconsistencies with the other policies. Therefore, when the conventional technology is used, the system administrator has to consider all the policies defined for the system and find discrepancies and inconsistencies to avert them. These operations are a considerable burden on the system administrator for a large-scale information processing system.

### SUMMARY OF THE INVENTION

The present invention is made to solve the foregoing problems, and has for its primary object to offer a program, an information processing device, an information processing device control method, and recording medium.

To solve the foregoing problems, a computer-readable medium containing a computer software program according to the present invention causes the information processing device within an information processing system to perform the step of receiving parameters entered for setting policies, which define the processes to be performed by the information processing system, and the step of changing the received parameters for the policies so as to ensure that a policy set, which is an aggregate of the policies set by the parameters, matches a control strategy of the information processing system.

The term “policy” herein represents information that defines a job (a process to be performed within the information processing system). The control strategy of the information processing system represents conditions that are imposed on the policy set.

The above and further problems and their solutions provided by the present invention will be clarified by the following description and accompanying drawings. Preferred embodiments of the present invention will be described in more detail referring to the accompanying drawings.

### BRIEF DESCRIPTION OF THE DRAWINGS

FIG. 1 is a block diagram illustrating the overall configuration of an information processing system according to a first embodiment.

FIG. 2 is a block diagram illustrating the configuration of a management server according to the first embodiment.

FIG. 3 is a block diagram illustrating the information processing system according to the first embodiment.

FIG. 4 shows a policy setup window according to the first embodiment.

FIG. 5 shows a setup window that opens after policy tuning according to the first embodiment.

FIG. 6 shows the contents of policies and global policies according to the first embodiment.

FIG. 7 shows a policy definition and configuration definition according to the first embodiment.

FIG. 8 shows a resource type table according to the first embodiment.

FIG. 9 shows a resource table according to the first embodiment.

FIG. 10 shows a global policy table according to the first embodiment.

FIG. 11 shows a policy type table according to the first embodiment.

FIG. 12 shows a policy table according to the first embodiment.

FIG. 13 shows a tuning parameter table according to the first embodiment.

FIG. 14 is a flowchart illustrating a policy setup procedure according to the first embodiment.

FIG. 15 shows a policy table that is prevalent after tuning according to the first embodiment.

FIG. 16 shows a weighting table according to the first embodiment.

FIG. 17 shows a weighting table according to the first embodiment.

FIG. 18 illustrates a policy set tuning operation according to the first embodiment.

FIG. 19 is a block diagram illustrating an information processing system according to a second embodiment.

FIG. 20 shows a policy definition and configuration definition according to the second embodiment.

FIG. 21 shows a resource definition according to the second embodiment.

FIG. 22 shows a tuning definition according to the second embodiment.

FIG. 23 shows a tuning parameter table according to the second embodiment.

FIG. 24 shows a global policy table according to the second embodiment.

FIG. 25 shows a policy type table according to the second embodiment.

FIG. 26 shows a policy type execution timing definition according to the second embodiment.

FIG. 27 shows a policy table according to the second embodiment.

FIG. 28 shows a processing sequence for tuning according to the second embodiment.

### DETAILED DESCRIPTION OF THE INVENTION

Embodiments of the present invention will now be described in detail with reference to the accompanying drawings.

[First Embodiment]

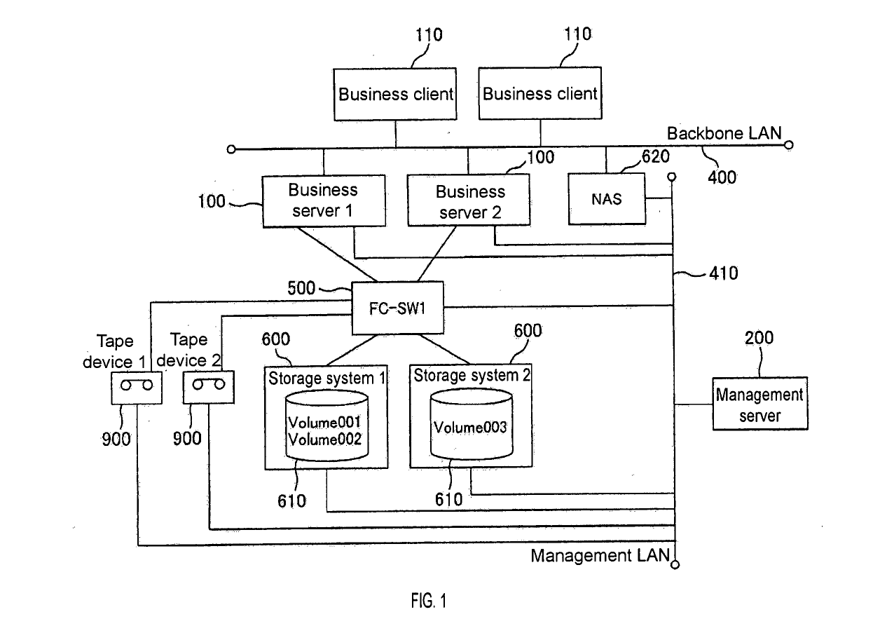

FIG. 1 is a block diagram illustrating the overall configuration of an information processing system according to a first embodiment. Business clients 110 are connected to business servers 100 (computers that access a storage device) via a backbone LAN (Local Area Network) 400. The business servers 100 and business clients 110 are computers that are equipped, for instance, with a CPU (Central Processing Unit), memory, and I/O device. Therefore, the business clients 110 can receive information processing services, which are provided by the business servers 100. The backbone LAN 400 may be a public network such as the Internet or an intranet.

The information processing services provided by the business servers 100 are not limited to specific types. They include on-line services such as a bank's automatic teller service and Internet home page browsing service as well as a batch processing service that provides experiment simulation in science and technology fields.

The business servers 100 are connected to storage systems (storage devices) 600 and tape devices (backup devices) 900 via FC-SW1 (Fibre Channel Switch 1, network device) 500. FC-SW1 500 is a switch that is used to interconnect the business servers 100, storage systems 600, and tape devices 900 with a SAN (Storage Area Network).

The storage systems 600 supply a storage resource that is required when a business server 100 provides an information processing service to a business client 110. The storage resource is stored on a logical volume (hereinafter sometimes referred to as a “volume”) 610, which is a storage area that is logically set within a physical storage area offered by a disk drive incorporated in a storage system 600. In the first embodiment, volume 001 and volume 002 are set for storage system 1 (storage system 600) and volume 003 is set for storage system 2 (storage system 600). A hard disk drive, flexible disk drive, semiconductor storage device, or other similar device that is directly connected to a server (e.g., SCSI or IDE connected) can be used as a disk drive.

As a storage system 600, a disk array may be formed with a plurality of disk drives. In this instance, a storage area may be offered to a business server 100 by a plurality of disk drives that are managed by RAID (Redundant Arrays of Inexpensive Disks).

A NAS (Network Attached Storage) 620 has a file system. As is the case with the storage systems 600, the NAS offers a storage area to the business servers 100. It also receives a file-specific data access request from the business servers 100 via the backbone LAN 400.

A management server (information processing device) 200 is connected to the business servers 100, FC-SW1 500, storage systems 600, NAS 620, and tape device 900 via a management LAN 410. As is the case with the backbone LAN 400, the management LAN 410 may be a public network such as the Internet or an intranet. The management server 200 is a computer that is equipped, for instance, with a CPU, memory, and I/O device. The management server 200 is combined with the storage systems 600 and other components to compose the information processing system.

The management server 200 is a computer for servicing and managing the information processing system. It is used, for instance, to perform setup for making the storage systems 600 available from the business servers 100, perform SAN setup, perform setup for allowing the business servers 100 to execute a batch process, and enabling the tape devices 900 to store data backups that are to be stored in the storage systems 600.

The management LAN 410 may be connected to the backbone LAN 400 or left unconnected to the backbone LAN 400. Further, the business servers 100 and business clients 110 may incorporate the functionality of the management server 200 so that the information processing system can be directly serviced, managed, and otherwise handled by the business servers 100 and business clients 110.

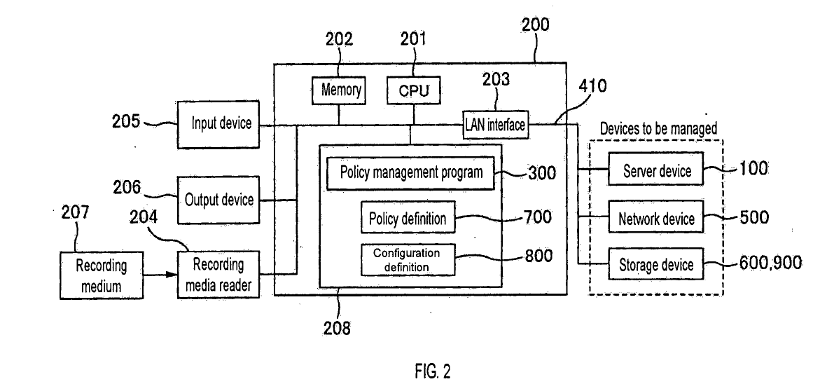

FIG. 2 is a block diagram illustrating the configuration of the management server 200 according to the first embodiment.

The management server 200 comprises a CPU 201, a memory 202, a LAN interface (LAN I/F) 203, a recording media reader 204, an input device 205, an output device 206, and a storage device 208.

The CPU 201 provides overall control of the management server 200. It exercises various functions according to the first embodiment by reading a policy management program 300, which is stored in the storage device 208, and executing the read policy management program 300 read to an adequate memory 202. The recording media reader 204 is a device for reading a program and data that are recorded on a recording medium (computer-readable medium) 207. The read program and data are stored in the memory 202 and storage device 208. For example, the policy management program 300 recorded on the recording medium 207 can therefore be read from the recording medium 207 by using the recording media reader 204 and stored in the memory 202 and storage device 208. As the recording medium 207, a flexible disk, CD-ROM, DVD-ROM, semiconductor memory, and other similar media may be used. The recording media reader 204 may be a device built in the management server 200 or an external device. The storage device 208 stores the policy management program 300, a policy definition 700, and a configuration definition 800, which will be detailed later. For example, a hard disk drive, flexible disk drive, or semiconductor storage device may be used as the storage device 208. The input device 205 is used, for instance, when an operator or other similar person enters data into the management server 200.

A keyboard, mouse, or other similar device is used as the input device 205. The output device 206 is used to transfer information to the outside. For example, a display or printer is used as the output device 206. The LAN interface 203 is a device for communicating with the business servers (server devices) 100, FC-SW1 (network device) 500, storage systems (storage devices) 600, and tape devices (storage devices) 900. It can also be used to communicate with a remote computer that is not shown. In such an instance, the policy management program 300 may be received from the remote computer via the LAN interface 203 and stored in the memory 202 and storage device 208.

The policy management program 300 checks whether a policy set, which is an aggregate of policies set by the operator at the time of information processing system servicing/management, matches a global policy (information processing system's control strategy). If the policy set does not match the global policy, the policy management program 300 enables the management server 200 to change the contents of the policies as needed for better matching. FIG. 18 shows a function that is exercised by the management server 200. The term “policy” represents information that defines a job (process to be performed). The term “global policy” represents conditions that are imposed on a policy set.

When a process (job) to be performed by various devices within the information processing system in relation to the management server 200 is defined by the operator as a policy, the management server 200 executes various device control commands so that various devices perform the process conforming to the policy. If, for instance, the operator sets a policy for “saving a backup of the data stored on volume 001 (610) onto tape device 1 (900) every Monday at 3:00 a.m.”, the management server 200 executes commands for controlling the volume 610 and tape device 900 so that a process is performed in conformance with the policy. When the information processing system is serviced and managed by using such a policy, the information processing system can be serviced and managed with increased ease so that enhanced work efficiency results.

However, when a large-scale information processing system is used, the operator has to set a large number of different types of policies so that the resulting servicing and management operations are complicated. If, for instance, a large number of volumes 610 are to be backed up, it is necessary to set a large number of policies. However, if such policies are incorrectly set up, an inconsistent policy setup may result so that different volumes 610 write data onto the same tape device 900 at the same time. Further, if a large number of backup processes are performed at the same time, a large amount of data passes through FC-SW1 500 so that the processing capacity of FC-SW1 500 may be exceeded.

Therefore, the policy management program 300 according to the first embodiment checks whether the policies set by the operator conforms to a global policy, and then changes the contents of the policies as needed to achieve better matching with the global policy. The policy definition 700 is an aggregate of tables for defining policies and global policies set by the operator. The configuration definition 800 is an aggregate of tables for defining the configuration of devices for an information processing system for which a policy is set.

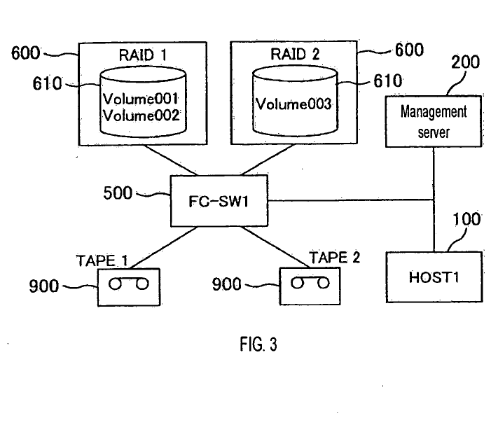

The control exercised by the management server 200, which executes the policy management program 300 according to the first embodiment, will now be described. FIG. 3 is a block diagram illustrating the components of an information processing system.

The management server 200 provides control over storage system 1 (RAID 1, 600), storage system 2 (RAID 2, 600), tape device 1 (TAPE 1, 900), tape device 2 (TAPE 2, 900), business server (HOST 1, 100), and FC-SW1 500. These devices have the same functions as the counterparts described with reference to FIG. 1.

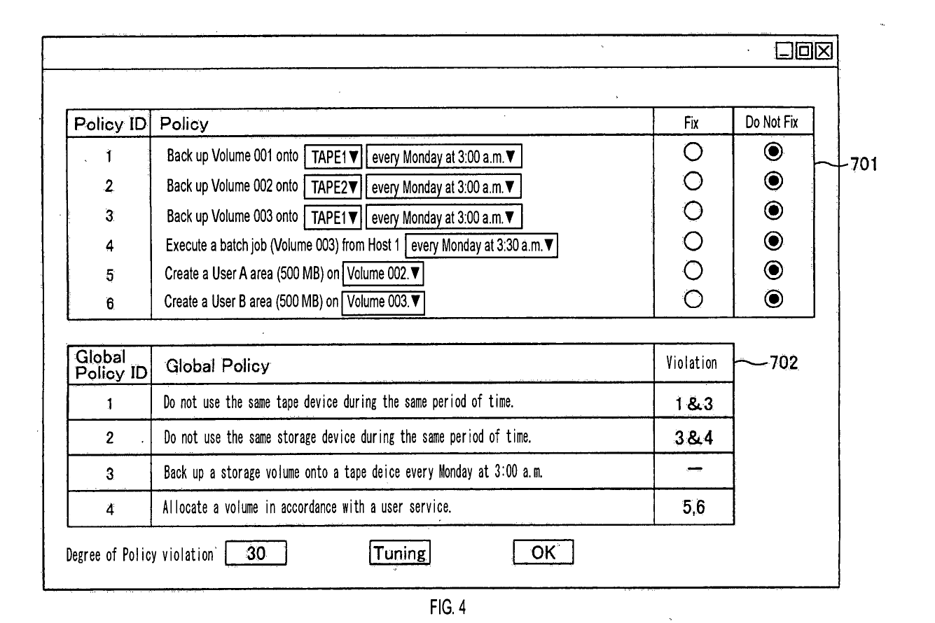

In the first embodiment, a window shown in FIG. 4 appears on a display device 206, which is an output device 206 for the management server 200. This window displays a policy display field 701, a global policy display field 702, a degree-of-policy-violation (degree-of-nonconformance) field, a tuning execution indication field, and an OK indication field.

The policy display field 701 has a “Policy ID” field, a “Policy” field, a “Fix” field, and a “Do Not Fix” field.

The “Policy ID” field displays an identification number that is assigned to a policy.

The “Policy” field is used for policy setup. In the example shown in FIG. 4, a total of six policies are set: “Back up volume 001 onto tape 1 every Monday at 3:00 a.m.”, “Back up volume 002 onto to tape 2 every Monday at 3:00 a.m.”, “Back up volume 003 onto to tape 1 every Monday at 3:00 a.m.”, “Execute a batch job (volume 003) from host 1 every Monday at 3:30 a.m.”, “Create a user A area (500 MB) on volume 002”, and “Create a user B area (500 MB) on volume 003”. These six policies constitute a policy set. The volume (e.g., “Volume 001” for policy ID 1), schedule (e.g., “every Monday at 3:00 a.m.” for policy ID 1), tape device (e.g., “tape 1” for policy ID 1), host (e.g., “host 1” for policy ID 4), and user (e.g., “user A” for policy ID 5) are parameters for a policy.

Policies of the same type (e.g., policies for making a backup) can be identified by Policy ID, even if they have same parameters. Policy IDs 1 through 3 are for “saving a duplicate of data stored in a storage area possessed by a parameter-specified storage device into a parameter-specified backup device at a parameter-specified time”. Policy ID 4 is for “causing a parameter-specified computer to perform a batch process using data stored in a storage area possessed by a parameter-specified storage device at a parameter-specified time”. Policy IDs 5 and 6 are for “allocating a parameter-specified user a storage area having a parameter-specified size, which is within a storage area possessed by a parameter-specified storage device”.

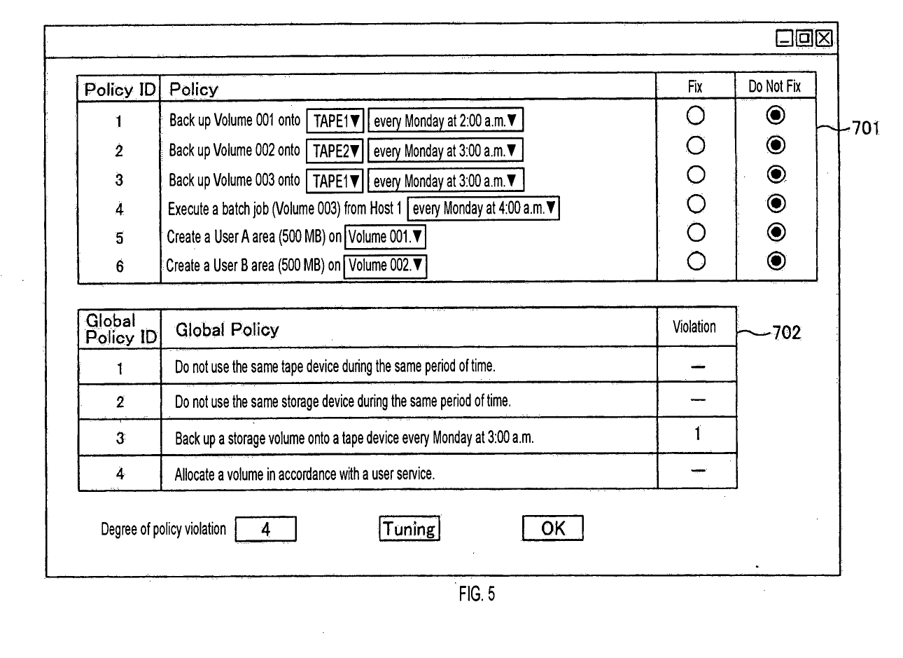

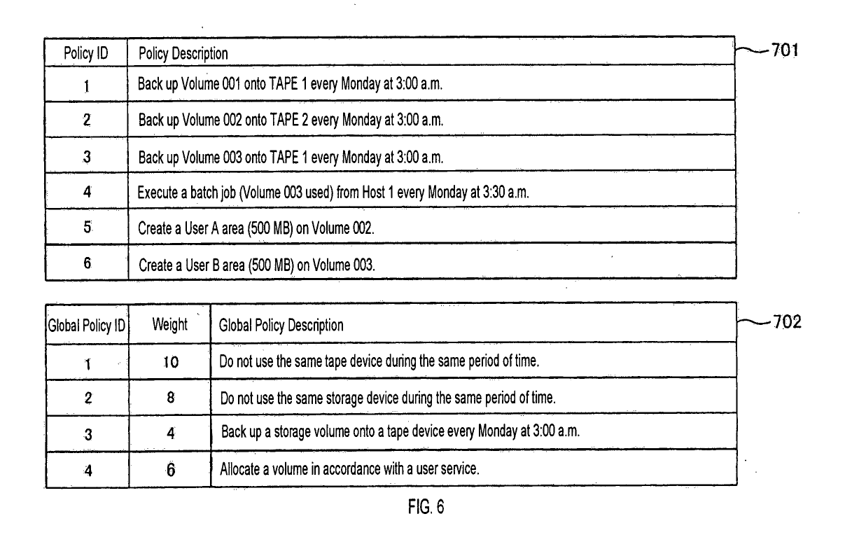

Policy parameter settings enclosed within a square having a downward triangular mark shown in FIG. 4 can be changed. It goes without saying that the other parameter settings may be rendered changeable. More specifically, when the operator uses a mouse or other similar input device (a receiver of a parameter input) 205 to click a downward triangular mark, a sub window opens, allowing the operator to change a parameter setting. A keyboard or other similar input device 205 may be used to directly enter a parameter setting. Further, when a mouse or other similar input device 205 is used to click the tuning execution indication field, the management server 200, which executes the policy management program 300, checks whether policy IDs 1 through 6 conform to a global policy. If any nonconformance is encountered, the associated parameter setting is changed. FIG. 6 presents a list 701, which shows the contents of policies.

Turning back to FIG. 4, the “Fix” field and “Do Not Fix” field are used to specify whether or not to allow the management server 200 to change parameter settings when a mouse or other similar input device is clicked on the tuning execution indication field. More specifically, when a mouse or like device is clicked on the tuning execution indication field in a situation where “Fix” is chosen, the management server 200 does not change the associated policy parameter setting. If, on the other hand, a mouse or like device is clicked on the tuning execution indication field in a situation where “Do Not Fix” is chosen, the management server 200 may change the associated policy parameter setting.

The global policy display field 702 has a “Global Policy ID” field, a “Global Policy” field, and a “Violation” field.

The “Global Policy ID” field displays an identification number that is assigned to a global policy.

The “Global Policy” field displays a global policy. In the example shown in FIG. 4, a total of four global policies are displayed: “Do not use the same tape device during the same period of time”, “Do not use the same storage device during the same period of time”, “Back up a storage volume onto a tape device every Monday at 3:00 a.m.”, and “Allocate a volume in accordance with a user service”.

The above global policies respectively correspond to “A plurality of policies do not exist for controlling the same backup device during the same period of time”, “A plurality of policies do not exist for controlling the same storage device during the same period of time”, “A process for saving a duplicate of data stored in a storage area possessed by a storage device into a backup device should start at a specified time”, and “A storage area possessed by a storage area to be allocated to a user should be a storage area that can be allocated to a user”.

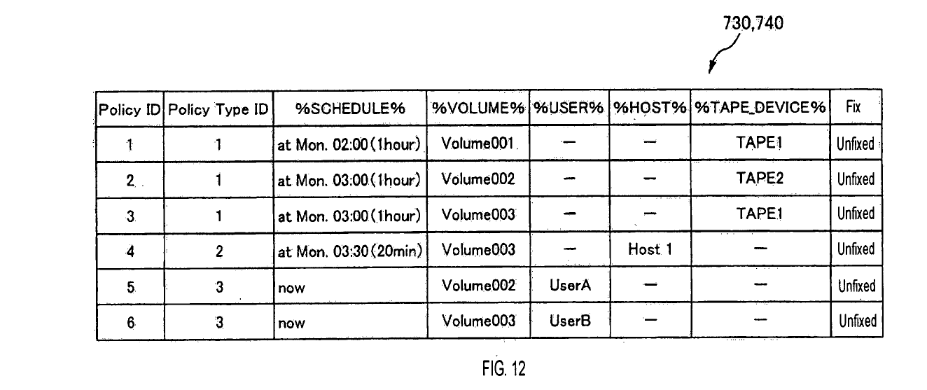

The “Violation” field indicates policies that do not conform to a global policy. In the example shown in FIG. 4, policy IDs 1 and 3 do not conform to global policy ID 1. The reason is that policy IDs 1 and 3 begin to use tape device 1 at 3:00 a.m. Monday. Further, policy IDs 3 and 4 do not conform to global policy ID 2. The reason is that policy IDs 3 and 4 begin to use volume 003 at 3:30 a.m. Monday. (Although not shown in FIG. 4, the backup process for policy ID 3 takes 1 hour. It will be explained with reference to FIG. 12.) All policies conform to global policy ID 3. The reason is that policy IDS 1 through 3 back up Volumes 001 through 003 at 3:00 a.m. Monday. Policy IDs 5 and 6 do not conform to global policy ID 4. Details will be given later, but it should be noted that volume 001 is allocatable to user A whereas volume 002 is allocatable to user B.

The degree-of-policy-violation (degree-of-nonconformance) field numerically indicates the degree of nonconformance of a policy set to a global policy. The degree-of-nonconformance value is calculated by multiplying the coefficient setting for a global policy by the number of policy combinations nonconforming to the global policy and adding up the resulting values for all global policies. The “policy combination” may be a combination of a plurality of policies or a combination formed by a single policy.

Although not shown in FIG. 4, the coefficients set for global policy IDs 1 through 4 are 10, 8, 4, and 6, respectively. As mentioned above, one policy combination (policy IDs 1 and 3) is nonconforming to global policy ID1; one policy combination (policy IDs 3 and 4) is nonconforming to global policy ID 2; no combination is nonconforming to global policy ID 3; and two policy combinations (policy IDs 5 and 6) are nonconforming to global policy ID 4. Thus, the degree of nonconformance is (10×1)+(8×1)+(4×0)+(6×2)=30. FIG. 6 shows a list that indicates coefficient (weight) settings for the global policies and the contents of the global policies.

In the first embodiment, the degree-of-nonconformance value is used to indicate the degree of nonconformance of a policy set to a global policy. However, a degree-of-conformance value may alternatively be used to indicate the degree of conformance. The degree-of-conformance value can be calculated by multiplying the coefficient setting for a global policy by the number of policy combinations conforming to the global policy and adding up the resulting values for all global policies.

Turning back to FIG. 4, when the operator uses a mouse or other similar input device 205 to click the tuning execution indication field, the policies are checked to determine whether they conform to a global policy. When the policies do not conform to the global policy, the parameter settings for the policies are changed, and the degree-of-nonconformance value indicated in the degree-of-policy-violation field is recalculated. When the operator is satisfied with the contents of a policy set after several tuning sessions, the operator clicks a mouse or other similar input device 205 on the OK indication field. The contents of the policy set are then determined, and the management server 200 executes commands for controlling various devices within the information processing system so that the devices perform processes in accordance with the policies.

FIG. 5 shows how the policies are changed when a mouse or other similar input device 205 is used to click the tuning execution indication field.

In the example shown in FIG. 5, the execution schedule for policy ID 1 is changed from 3:00 a.m. to 2:00 a.m.; the execution schedule for policy ID 4 is changed from 3:30 a.m. to 4:00 a.m.; the volume for policy ID 5 is changed to volume 001; and the volume for policy ID 6 is changed to volume 002.

As a result of the above changes, no policies fail to conform to global policy IDs 1, 2, and 4. However, policy ID 1 fails to conform to global policy ID 3. Thus, the degree of nonconformance is 4 ((10×0)+(8×0)+(4×1)+(6×0)=4). The value 4 is therefore displayed in the degree-of-policy-violation field.

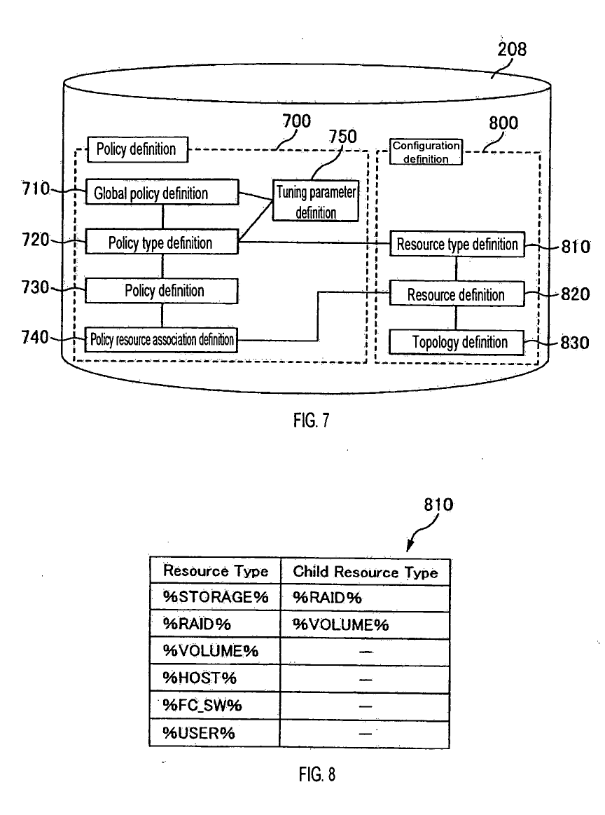

FIG. 7 shows a policy definition 700 and a configuration definition 800. The policy definition 700 comprises a global policy definition 710, a policy type definition 720, a policy definition 730, a policy resource association definition 740, and a tuning parameter definition 750. The configuration definition 800 comprises a resource type definition 810, a resource definition 820, and a topology definition 830.

The resource type definition 810 is a table for defining the types of information processing system component devices, which are targeted for management. FIG. 8 shows a resource type definition 810 according to the first embodiment.

The resource type definition 810 according to the first embodiment comprises a “Resource Type” field and a “Child Resource Type” field.

The “Resource Type” field shows the definitions of management target types. In the first embodiment, “% STORAGE %”, “% RAID %”, “% VOLUME %”, “% HOST %”, “% FC-SW %”, and “% USER %” are defined. “% STORAGE %” is a definition of storage equipment, that is, all storage devices including storage system 1 (600) and storage system 2 (600). “% RAID %” is a definition of a specific storage device included in the storage equipment, that is, storage system 1 (600) or storage system 2 (600). “% VOLUME %” is a definition of a volume that is set within a storage device, that is, a volume 610 that is set within storage system 1 (600) or storage system 2 (600). “% HOST %” is a definition of a server device, that is, a business server (HOST 1) 100. “% FC-SW %” is a definition of a network device, that is, FC-SW1 500. “% USER %” is a definition of a person who uses various resources (volumes 610, etc.), which are offered by the information processing system via a business server 100, business client 110, and management server 200.

The “Child Resource Type” field is used to define a management target that is included among the management targets defined in the “Resource Type” field. More specifically, “% STORAGE %” includes “% RAID %”. “% RAID %” includes “% VOLUME %”. No management target is included in “% VOLUME %”, “% HOST %”, “% FC-SW %”, or “% USER %”.

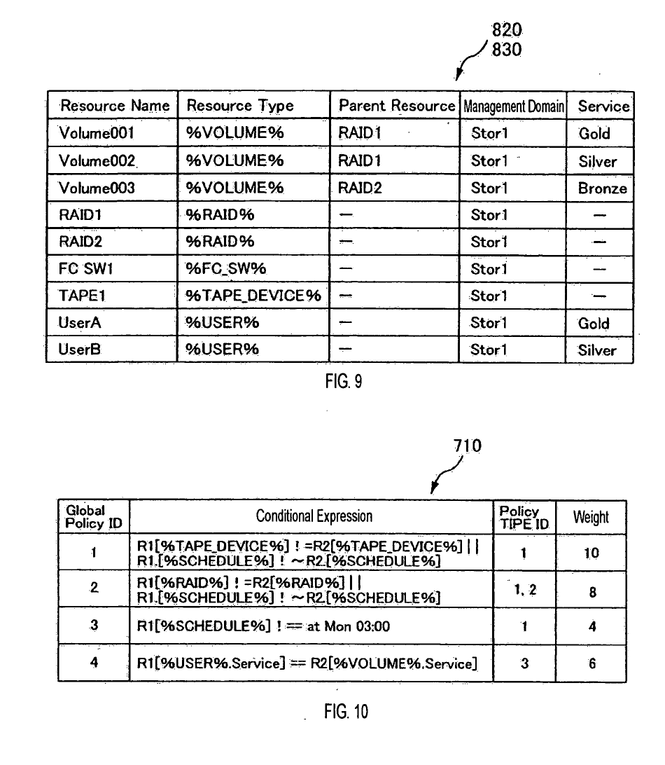

The resource definition 820 is a table for defining actual management targets (e.g., information processing system component devices and personnel) that correspond to a management target type defined by the resource type definition 810. The topology definition 830 is a table for defining the topologies of actual management targets that correspond to a management target type defined by the resource type definition 810. FIG. 9 shows a resource definition 820 and topology definition 830 according to the first embodiment.

The resource definition 820 and topology definition 830 according to the first embodiment comprise a “Resource Name” field, a “Resource Type” field, a “Parent Resource” field, a “Management Domain” field, and a “Service” field. The “Management Domain” field corresponds to the topology definition 830.

The “Resource Name” field is used to define actual management targets. In the first embodiment, the actual management targets are “Volume 001” 610, “Volume 002” 610, “Volume 003” 610, “RAID 1” 600, “RAID 2” 600, “FC-SW1” 500, “TAPE 1” 900, “TAPE 2” 900, “Host 1” 100, “User A”, and “User B”. The “Resource Type” field is used to define the types of management targets that are written in the “Resource Name” field. The “Parent Resource” field is used to define higher-level management targets for various management targets. The “Management Domain” field is used to define the names of domains to which management targets belong.

In the first embodiment, all management targets belong to a management domain named “Stor1”. When classified into a plurality of management domains, the management targets can be managed on an individual management domain basis. The “Service” field is used to define the authorities that are granted to the management targets. For example, an authority identified by “Gold” is granted to “User A”, whereas an authority identified by “Silver” is granted to “User B”. In this instance, “User A” is not allowed to use “Volume 002” 610. The reason is that “User A” does not have an authority identified by “Silver”, which is granted to “Volume 002” 610.

The global policy definition 710 is a table for defining global policies. FIG. 10 shows a global policy definition 710 according to the first embodiment.

The global policy definition 710 according to the first embodiment comprises a “Global Policy ID” field, a “Conditional Expression” field, a “Policy Type ID” field, and a “Weight” field. The “Global Policy ID” field is used to define the identification numbers that are assigned to global policies.

The “Conditional Expression” field is used to define the contents of a global policy. In the first embodiment, “R1[% TAPE_DEVICE %]!=R2[% TAPE_DEVICE %]||R1[% SCHEDU LE %]!˜R2[% SCHEDULE %]” is defined for global policy ID 1. “R1[ ]!=R2[ ]” is a logical expression that is True when the parameters (% TAPE_DEVICE %) displayed within square brackets ([ ]) for two different policies do not match. “R1[ ]!˜R2[ ]” is a logical expression that is True when the parameters (% SCHEDULE %) displayed within square brackets ([ ]) for two different policies do not overlap. “||”, which joins the above two logical expressions, represents OR. Therefore, global policy ID 1 imposes the “Do not use the same tape device during the same period of time” condition on a policy set.

“R1[% RAID %]!=R2[% RAID %]||R1[% SCHEDULE %]!˜R2[% SCHEDULE %]” is defined for global policy ID 2. Global policy ID 2 imposes the “Do not use the same storage device during the same period of time” condition on a policy set.

“R1[% SCHEDULE %]!==at Mon 03:00” is defined for global policy ID 3. It is a logical expression that is True when the time identified by “% SCHEDULE %” is not 3:00 a.m. Monday. Therefore, when this global policy is applied to a policy set that is an aggregate of policies defined as “Save a duplicate of data stored in a storage area possessed by a parameter-specified storage device into a parameter-specified backup device at a parameter-specified time”, it imposes the “The process for saving a duplicate of data stored in a storage area possessed by a storage device into a backup device should start at a specified time” condition on the policy set.

“R1[% USER %.Service]==R2[% VOLUME %.Service]” is defined for global policy ID 4. It is a logical expression that is True when the authority granted to a user identified by “% USER %” is equal to the authority granted to a volume 610 defined by “% VOLUME %”. The authority granted to a user and volume 610 can be determined by referencing the resource definition 820 shown in FIG. 9. Therefore, when this global policy is applied to a policy set that is an aggregate of policies defined as “Allocate a parameter-specified user a storage area having a parameter-specified size, which is within a storage area possessed by a parameter-specified storage device”, it imposes the “The storage area possessed by a storage device to be allocated to a user should be a storage area that is allocatable to the user” condition on the policy set.

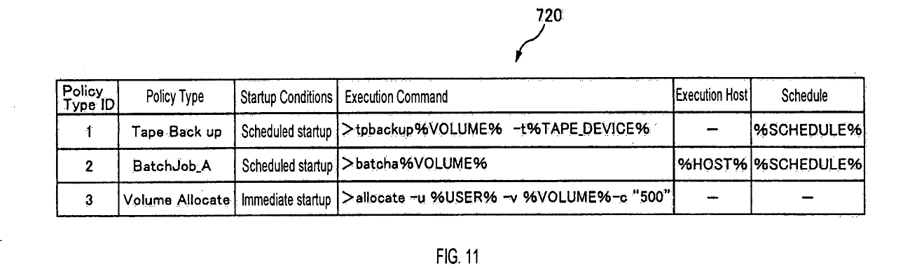

The “Policy Type ID” field is used to define a policy type to which a global policy is applied. The policy type definition 720 will now be described with reference to FIG. 11.

The policy type definition 720 is a table for defining policy types. Policy setup can be performed by setting specific information for various parameters for policy types. In the first embodiment, three policy types are defined: “Tape Backup”, “BatchJob_A”, and “VolumeAllocate”. “Tape Backup” is for saving a duplicate of data stored in a storage area possessed by a parameter (% VOLUME %)-specified storage device into a parameter (% TAPE_DEVICE %)-specified backup device at a parameter (% SCHEDULE %)-specified time. “BatchJob-A” is for causing a parameter (% HOST %)-specified computer to perform a batch process by using data stored in a storage area possessed by a parameter (% VOLUME %)-specified storage device at a parameter (% SCHEDULE %)-specified time. “VolumeAllocate” is for allocating a parameter (% USER %)-specified user a storage area having a parameter (“500”)-specified size, which is within a storage area possessed by a parameter (% VOLUME %)-specified storage device. The parameters for various policy types are defined in an “Execution Command” field, “Execution Host” field, and “Schedule” field.

The term “scheduled startup” in a startup conditions field means that a policy will be executed in accordance with a schedule specified by the % SCHEDULE% parameter. For example, “event-driven startup” and “immediate startup” may be set in addition to “scheduled startup”. The term “event-driven startup” means that a policy will be executed when a predefined event occurs. “Event-driven startup” can be used, for instance, to execute a policy in the event of a predefined failure. “Immediate startup” initiates execution immediately.

Turning back to FIG. 10, the “Policy Type ID” field is used to define policy types to which global policies are applied.

The “Weight” field defines the coefficient setting for a global policy, which is used to calculate the degree of nonconformance of a policy set to a global policy. In the first embodiment, the coefficient setting is 10 for global policy ID 1, 8 for global policy ID 2, 4 for global policy ID 3, and 6 for global policy ID 4.

The policy definition 730 and policy resource association definition 740 are tables for defining policies. A policy definition can be formulated by setting specific data for individual policy type parameters. FIG. 12 shows a policy definition 730 and policy resource association definition 740 according to the first embodiment.

The policy definition 730 according to the first embodiment comprises a “Policy ID” field, a “Policy Type ID” field, a “% SCHEDULE %” field, a “% VOLUME %” field, a “% USER %” field, a “% HOST %” field, a “% TAPE_DEVICE %” field, and a “Fix” field. The “% VOLUME %” field, “% USER %” field, “% HOST %” field, and “% TAPE_DEVICE %” field correspond to the policy resource association definition 740.

The “Policy ID” field is used to define an identification number that is assigned to a policy. The “Policy Type ID” field indicates the type of the policy. In the first embodiment, it is stated that the type for policy IDs 1 through 3 is Policy Type 1, that is, “Tape Backup”. It is also stated that the type for policy ID 4 is Policy Type 2, that is, “BatchJob_A”. Further, it is stated that the type for Policy IDs 5 and 6 is Policy Type 3, that is, “VolumeAllocate”.

The “% SCHEDULE %” field, “% VOLUME %” field, “% USER %” field, “% HOST %” field, and “% TAPE_DEVICE %” field are used to define the parameter values for defining various policies. In the “% SCHEDULE %” field, the time for starting the execution of a policy and the length of processing time are written. For example, the “% SCHEDULE %” field for policy ID 1 indicates that execution starts at 3:00 a.m. Monday and that the length of processing time is 1 hour. The “% VOLUME %” field indicates a volume 610 that is used for executing the policy. The “% USER %” field indicates a user who is involved with the policy. The “% HOST %” field indicates a business server 100 that is used for executing the policy. The “% TAPE_DEVICE %” field indicates a tape device 900 that is used for executing the policy.

The “Fix” field is used to specify whether or not to change the parameter settings at the time of tuning. If “Unfixed” is written in this field, the parameter settings will be changed at the time of tuning. If “Fixed” is written in this field, on the other hand, the parameter settings will remain unchanged at the time of tuning.

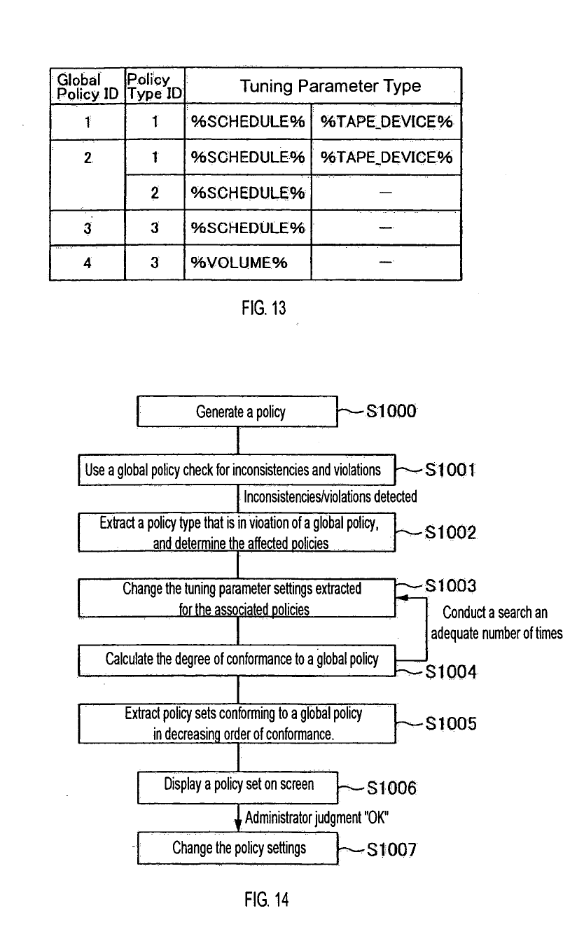

The tuning parameter definition 750 is a field that relates to the parameters for various policy types shown in FIG. 11 and specifies the parameter settings to be changed at the time of tuning. FIG. 13 shows a tuning parameter definition 750 according to the first embodiment.

The tuning parameter definition 750 according to the first embodiment comprises a “Global Policy ID” field, a “Policy Type ID” field, and a “Tuning Parameter Type” field. It concerns all policy types to which global policies apply, and specifies the parameter settings to be changed at the time of tuning. In the example shown in FIG. 13, % SCHEDULE % and % TAPE_DEVICE % are to be changed when tuning is conducted with global policy 1 applied to policy type 1.

FIG. 14 is a flowchart illustrating a process that is performed for policy setup according to the first embodiment. The process described below is performed when the CPU 201 executes the policy management program 300, which comprises the codes for performing various operations according to the first embodiment.

First, a policy is generated (step S1000). Policy generation is initiated by setting values for the parameters for various policy types. More specifically, policy generation takes place when various parameter values entered by the operator from the window shown in FIG. 4 are accepted and registered as the policy definition 730 shown in FIG. 12.

Next, a policy set, which is an aggregate of policies, is checked to determine whether it conforms to a global policy. First, the global policy is used to check the policies (policy set) for inconsistencies and violations (nonconformances) (step S1001). In other words, the CPU 201 applies a conditional expression to policies belonging to policy types that are specified in the “Policy Type ID” field written in the global policy definition 710 shown in FIG. 10, extracts a policy type that is nonconforming to or in violation of a global policy, and determines the affected policies (step S1002). More specifically, the CPU 201 applies a conditional expression to policies ID 1 through 3, which belong to policy type ID 1, in the case of global policy ID 1. It is then found that the conditional expression is False for policies ID 1 and 3. It means that policies ID 1 and 3 do not conform to global policy 1. In the case of global policy ID 2, the CPU 201 applies the conditional expression to policies ID 1 through 4, which belong to policy type ID 1 or 2. It is then found that the conditional expression is False for policies ID 3 and 4. It means that policies ID 3 and 4 do not conform to global policy 2. In the case of global policy ID 3, the CPU 201 applies the conditional expression to policies ID 1 through 3, which belong to policy type ID 1. It is then found that the conditional expression is True for policies ID 1 through 3. It means that policies ID 1 through 3 conform to global policy 3. In the case of global policy ID 4, the CPU 201 applies the conditional expression to policies ID 5 and 6, which belong to policy type ID 3. It is then found that the conditional expression is False for policies ID 5 and 6. It means that policies ID 5 and 6 do not conform to global policy 4.

Next, the CPU 201 (a changer of parameter settings) changes the tuning parameter settings extracted for the associated policies (step S1003). The tuning parameter settings to be changed are specified according to the tuning parameter definition 750 shown in FIG. 13. More specifically, the CPU 201 changes % SCHEDULE % and % TAPE_DEVICE % for policies ID 1 and 3, which do not conform to global policy 1. Further, the CPU 201 changes % SCHEDULE% and % TAPE_DEVICE % for policy ID 3, which do not conform to global policy 2, and changes % SCHEDULE % for policy ID 4, which do not conform to global policy 2. Furthermore, the CPU 201 changes % VOLUME % for policies ID 5 and 6, which do not conform to global policy 4.

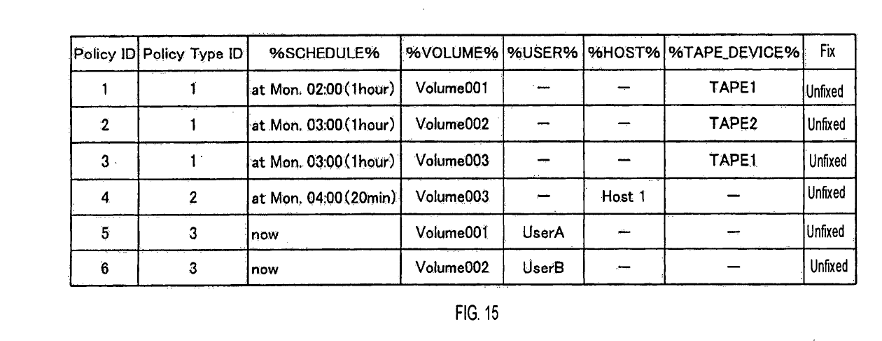

The above changes are effected in accordance with the policy definition 730 shown in FIG. 12. When % SCHEDULE % is to be changed for policies ID 1 and 3, the CPU 201 finds that the required backup processing time is 1 hour in accordance with FIG. 12. Therefore, the CPU 201 then finds that global policy 1 will be complied with if the execution start time for policy ID 1 or 3 is shifted by 1 hour. Thus, the CPU 201 first changes % SCHEDULE % so that the execution of policy ID 1 begins 1 hour earlier. When % SCHEDULE % is to be changed for policies ID 3 and 4, the CPU 201 finds that the backup processing time required for policy ID 3 is 1 hour in accordance with FIG. 12, and that the batch processing time required for policy ID 4 is 20 minutes. Therefore, the CPU 201 then finds that global policy 2 will be complied with if the execution of policy ID 3 begins 30 minutes earlier or the execution of policy ID 4 begins 30 minutes later. Thus, the CPU 201 first changes % SCHEDULE % so that the execution of policy ID 4 begins 30 minutes later. When % VOLUME % is to be changed for policies ID 5 and 6, the CPU 201 references the resource definition 820 shown in FIG. 9, searches for a volume that is granted an authority matching the authority granted to the user, and switches to such a volume. FIG. 15 shows how the parameter settings for the policy definition 730 are changed.

Subsequently, the CPU 201 calculates the degree of nonconformance to a global policy (step S1004). In the example shown in FIG. 15, all policies conform to global policies 1, 2, and 4; however, policy ID 1 does not conform to global policy 3. The degree of nonconformance is calculated by multiplying the coefficient setting for a global policy by the number of policy combinations nonconforming to the global policy and adding up the resulting values for all global policies. Thus, the calculated degree of nonconformance is 4 ((10×0)+(8×0)+(4×1)+(6×0)=4). In this manner, the CPU 201 changes the parameter settings for the policies so as to decrease the degree of nonconformance.

When % TAPE_DEVICE % is to be changed at the time of tuning, a switch to TAPE 1 or TAPE 2 can be made by referencing the resource definition 820 shown in FIG. 9.

When, for instance, a % SCHEDULE % or % TAPE_DEVICE % parameter setting is to be changed, there are many associated combinations. However, the CPU 201 either searches for all such parameter combinations or selects one combination using a genetic algorithm or like technique and calculates the degree of nonconformance.

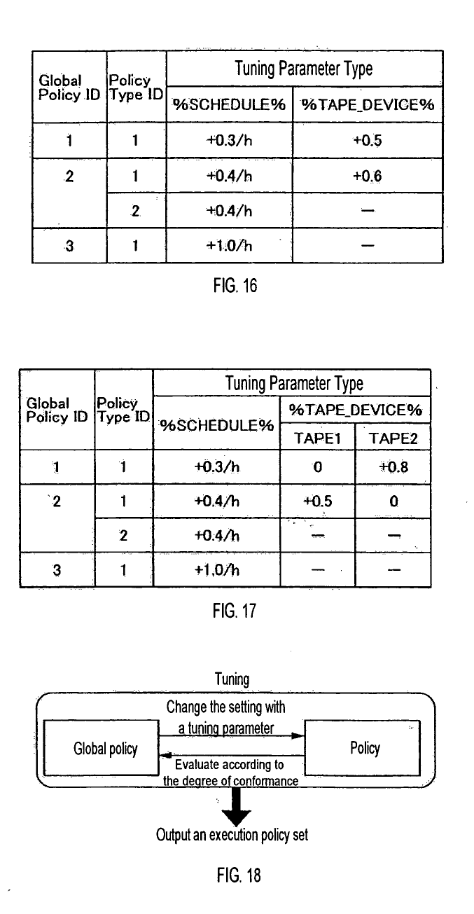

The degree of nonconformance can also be calculated by additionally using a weighting table shown in FIG. 16 or 17. More specifically, a weighting coefficient selected for the % SCHEDULE %, % TAPE_DEVICE %, or other parameter to be changed is added to the degree-of-nonconformance value, which is determined by the above method.

When, for instance, a parameter setting for policy type ID 1 to which global policy ID 1 is applied is to be changed in relation to the example shown in FIG. 16, the value +0.3 is added for each one hour change in the % SCHEDULE % setting and the value +0.5 is added for a % TAPE_DEVICE % change from a default tape device. When the weighting coefficients are added in this manner, the degree-of-nonconformance value increases with an increase in the deviation from the original contents of a policy set that is defined by the operator. Therefore, it is possible to define a policy set that matches a global policy better while minimizing the change to be applied to the original contents of a policy set that is defined by the operator.

In the example shown in FIG. 17, the weight for each tape device is fixed. This ensures that the degree-of-nonconformance value can be increased when a specific tape device is not used. It is therefore possible to define a policy set that matches a global policy better while minimizing the change to be applied to the original contents of a policy set that is defined by the operator.

The above process is repeated an adequate number of times for different parameter combinations to determine the degree of nonconformance of each combination, and then the window displayed on the management server 200 shows a policy set (steps S1003 to S1006).

When operator is satisfied with the contents of the policy set, the operator puts the contents of the policy set into final form and terminates the process (step S1007).

The process described above can detect discrepancies and inconsistencies of policies that are set by the operator at the time of information processing system servicing/management operations. It also makes it possible to find more appropriate policies. The management server 200 presents more appropriate policies together with a value indicating the degree of nonconformance to a global policy. Therefore, the operator can objectively grasp the degree of nonconformance of a policy set to a global policy and set up an optimum policy set for an information processing system targeted for management. This makes it possible to reduce the management load on the operator who manages an information processing system.

If the parameter settings for a specific policy should remain unchanged when the management server 200 tunes a policy set, the first embodiment can instruct the management server 200 to leave such a policy unchanged. This feature makes it possible to generate a policy set that is free from discrepancies and inconsistencies, while allowing the operator's intention to take precedence.

With the first embodiment, it is also possible to add the weighting coefficient in such a manner as to increase the degree of nonconformance as the deviation from an original parameter setting entered by the operator increases when the management server 200 tunes a policy set. This feature makes it possible to define a policy set that matches a global policy better, while minimizing the change to be applied to the original contents of a policy set defined by the operator.

As described above, the first embodiment can reduce the management load on the operator who manages an information processing system.

Although the first embodiment has been described, the described embodiment is to be considered in all respects only as illustrative and not restrictive. The scope of the present invention is indicated by the appended claims, rather than the foregoing description, and all changes that come within the meaning and range of equivalence thereof are intended to be embraced therein.

Another embodiment will now be described.

[Second Embodiment]

The overall configuration of an information processing system according to the second embodiment and the configuration of a management server 200 are based on those of the first embodiment.

Control exercised by the management server 200, which executes a policy management program 300 according to the second embodiment, will now be described.

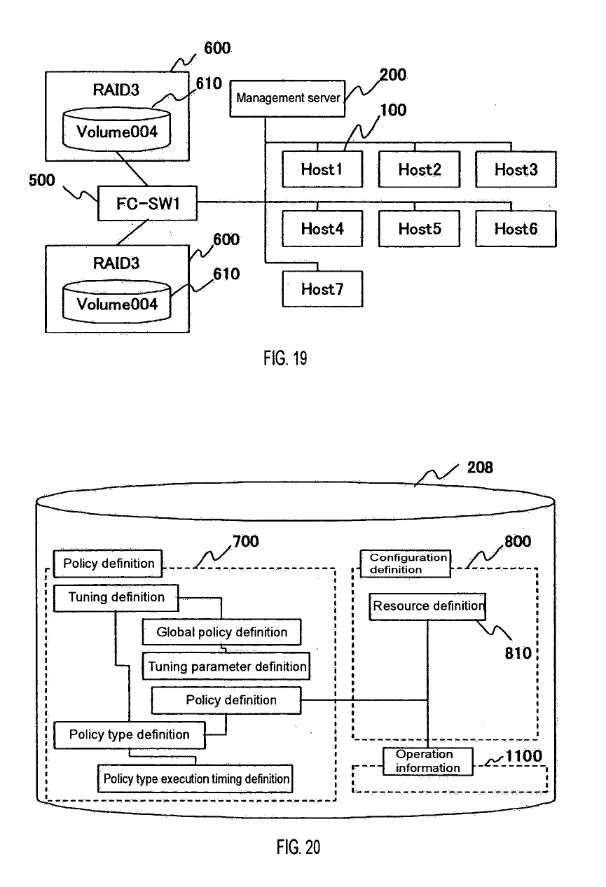

FIG. 19 is a block diagram illustrating the components of the information processing system. The management server 200 exercises control over storage system 3 (RAID 3, 600), storage system 4 (RAID 4, 600), and business servers (Host 2, Host 3, Host 4, Host 5, Host 6, and Host 7) in addition to the components shown in FIG. 3. These devices have the same functions as those described with reference to FIG. 1. RAIDs 1 to N are not control method identifiers but merely represent different RAID devices.

FIG. 20 shows a policy definition 700, a configuration definition 800, and operation information 1100. The policy definition 700 comprises a tuning definition 760, a global policy definition 710, a tuning parameter definition 750, a policy definition 730, a policy type definition 720, and a policy execution timing definition 770. The configuration definition 800 comprises a resource definition 820. The management server 200 according to the second embodiment comprises an information collection engine 209, which acquires the information about the operation and performance of devices targeted for management. The information collection engine 209 collects information and stores it as the operation information 1100. In other words, the information collection engine 209 stores the information about the devices targeted for management as the operation information 1100.

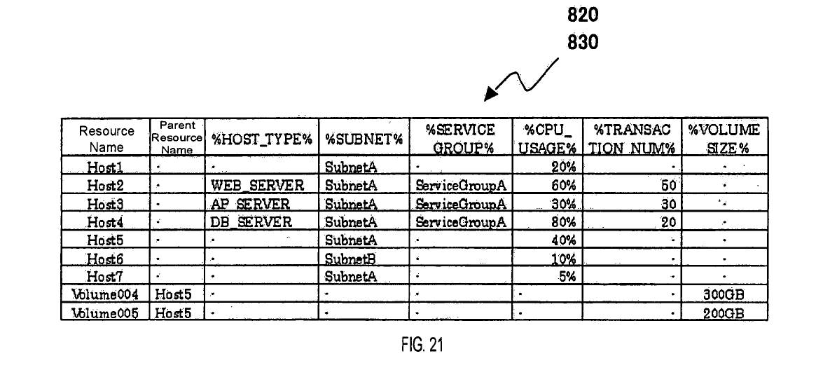

The resource definition 820 is a table for storing the information about the operation status. FIG. 21 shows a resource definition 820 according to the second embodiment. The resource definition 820 according to the second embodiment comprises a “Resource Name” field, “Parent Resource Name” field, a “% HOST_TYPE %” field, a “% SUBNET %” field, a “% SERVICEGROUP %” field, a “% CPU_USAGE %” field, a “% TRANSACTION_NUM %” field, and a “% VOLUMESIZE %” field. The “Resource Name” field is used to define a name that identifies a management target. For a resource that is included as a part of a specific resource, a resource name that is to be contained in the “Parent Resource Name” field is defined. The “% HOST_TYPE %” field is used to define the business type of a business server. The definition entry in the “% HOST_TYPE %” field corresponds to a resource type definition shown in FIG. 7. The “% SUBNET %” field is used to define a name that identifies a subnet within a network configuration. The “% SERVICEGROUP %” field is used to define the type of a service that is provided by a resource. The definition entries in the “% SUBNET %” field and “% SERVICEGROUP %” field correspond to a topology definition 830 shown in FIG. 7. The CPU usage percent, processing transaction count, and available, free volume space (in bytes) are stored, respectively, in the “% CPU_USAGE %” field, “% TRANSACTION_NUM %” field, and “% VOLUMESIZE %” field. The contents of the “% CPU_USAGE %” field, “% TRANSACTION_NUM %” field, and “% VOLUMESIZE %” field are the operation performance information 1100 that is stored by the information collection engine 209. In addition to the operation performance information, these fields can store the information about availability, copy progress percentage, and the like. The operation performance information 1100 is stored periodically or when it is referenced.

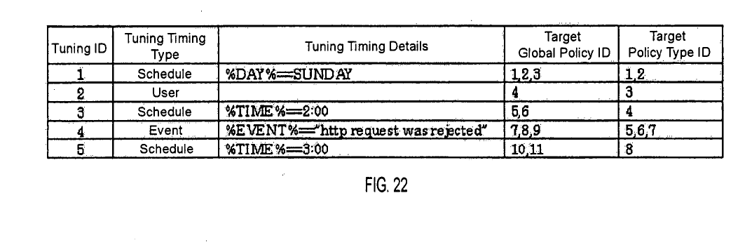

The tuning definition 760 defines the tuning timing, that is, the tuning conditions as well as the tuning target. FIG. 22 shows a tuning definition 760 according to the second embodiment. The tuning definition 760 according to the second embodiment comprises a “Tuning ID” field, a “Tuning Timing Type” field, a “Tuning Timing Details” field, a “Target Global Policy ID” field, and a “Target Policy Type ID” field.

The “Tuning ID” field defines the tuning timing and the ID for identifying the definition targeted for tuning. The “Tuning Timing Type” field defines the timing type for tuning. There are three tuning timing types: “Schedule” for performing a tuning process in accordance with a predetermined schedule, “Event” for performing a tuning process when a specific event occurs, and “User” for allowing the user to directly perform a tuning process. The “Tuning Timing Details” field defines the details of tuning timing. For example, “% DAY %=SUNDAY” means that tuning will be conducted every Sunday. The “Target Global Policy ID” field is used to specify a global policy as a tuning target. It is possible to designate all global policies for a certain tuning definition and designate a specific global policy for a plurality of tuning definitions. The “Target Policy Type ID” field is used to specify a policy type as a tuning target. The policies belonging to the policy type specified in this field will be targeted for tuning.

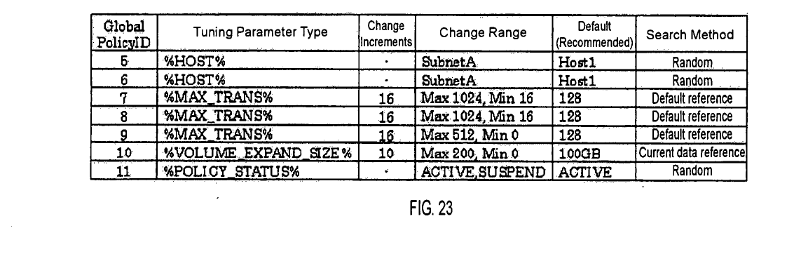

The tuning parameter definition 750 defines the tuning parameters targeted for the tuning of a global policy. FIG. 23 shows a tuning parameter definition 750 according to the second embodiment. The tuning parameter definition 750 according to the second embodiment comprises a “Global Policy ID” field, a “Tuning Parameter Type” field, a “Change Increments” field, a “Change Range” field, a “Default (Recommended)” field, and a “Search Method” field. The “Global Policy ID” field specifies a targeted global policy. The “Tuning Parameter Type” field specifies a tuning parameter type that is targeted for tuning. A plurality of tuning parameter types can be defined for a single global policy. When the tuning parameter type is a numerical value, the “Change Increments” field is used to specify the minimum increments for numerical value changes for tuning purposes.

The “Change Range” field specifies the tuning parameter change range. When “SubnetA” is entered in this field, it means that only the network elements belonging to subnet A are targeted for tuning.

The “Default (Recommended)” field defines an initial value or recommended value for tuning. The “Search Method” field specifies the value change method for tuning. If, as a result of tuning, the same degree of conformance is encountered, the contents of policies do not always agree with each other if they differ in the “Search Method”. There are three change methods: “Random”, “Default Reference”, and “Current Data Reference”. All these change methods presume that the “Change Range” will not be exceeded. The “Random” method specifies a tuning parameter randomly, that is, in accordance with a random number. The “Default Reference” method effects such a change as to select a value (numerical value) that is closest to the default one. The “Current Data Reference” method effects a change so as to select a value (numerical value) that is closest to the current tuning parameter. If the “Search Method” is other than “Random” and the tuning parameter is not a numerical value, it is necessary to use a separate table that defines a quantitative relationship among tuning parameters.

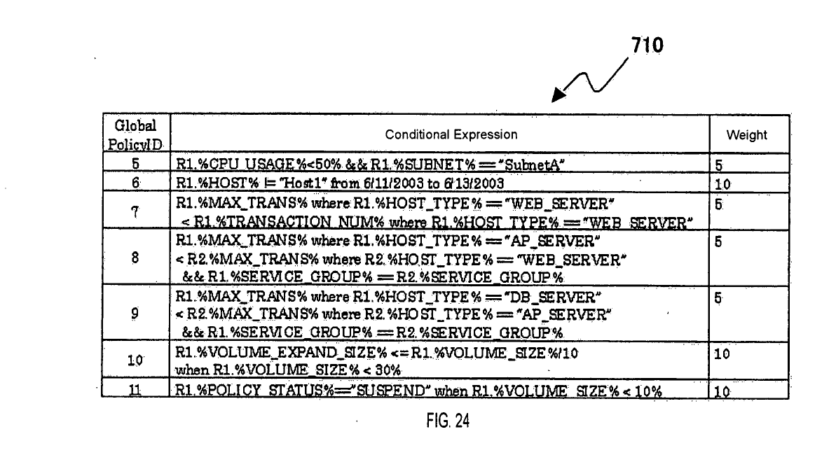

The global policy definition 710 specifies a global policy conditional expression and weight. FIG. 24 shows a global policy definition 710 according to the second embodiment. The global policy definition 710 according to the second embodiment will not be described again because it is the same as described with reference to FIG. 10.

The policy type definition 720 defines an execution command and execution host as a policy type.

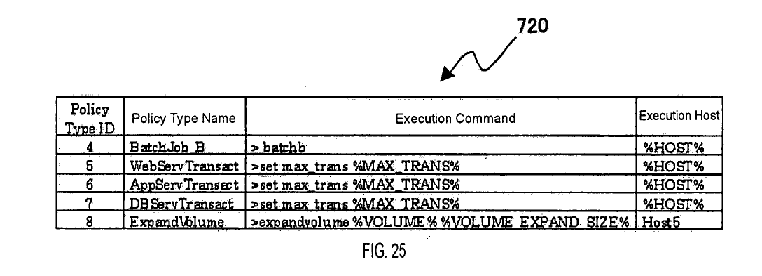

FIG. 25 shows a policy type definition 720 according to the second embodiment. The policy type definition 720 according to the second embodiment is the same as described with reference to FIG. 11 except that the “Startup Conditions” field and “Schedule” field are not included. In the second embodiment, the “Startup Conditions” and “Schedule” are defined separately by the policy execution timing definition 770. The execution host can be fixed by specifying a host name directly with the “Execution Host” field.

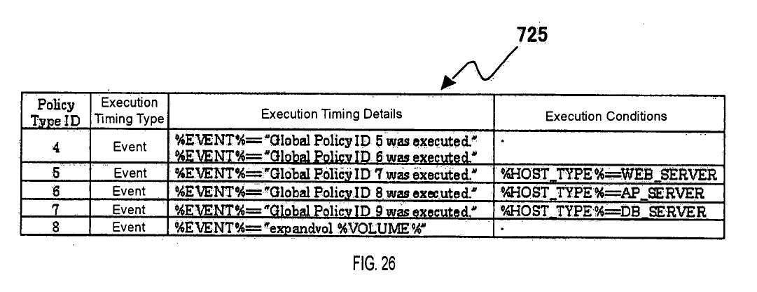

The policy execution timing definition 770 defines the execution timing for each policy type. FIG. 26 shows a policy execution timing definition 770 according to the second embodiment. The policy execution timing definition 770 according to the second embodiment comprises a “Policy Type ID” field, an “Execution Timing Type” field, an “Execution Timing Details” field, and an “Execution Conditions” field. The policy execution timing definition 770 is basically independent of tuning execution based on a global policy. It simply specifies the policy execution timing. In the second embodiment, the policy execution timing specified by a policy type applies. However, it is possible to specify the execution timing on an individual policy basis by specifying the execution timing in the policy definition 730. The “Policy Type ID” field specifies a targeted policy type. The “Execution Timing Type” field specifies a policy execution timing type. There are two policy execution timing types: “Event” for initiating execution when a specific event occurs and “Schedule” for initiating execution in accordance with a predetermined schedule. The “Execution Timing Details” field defines the details of policy execution timing. FIG. 26 shows an example in which the execution timing type is “Event” and the “Execution Timing Details” field is used to specify the event occurrence conditions. The “Execution Conditions” field defines the policy execution conditions. “% HOST_TYPE %=WEB_SERVER” means that policy execution starts if the host generating an event is of the WEB_SERVER type.

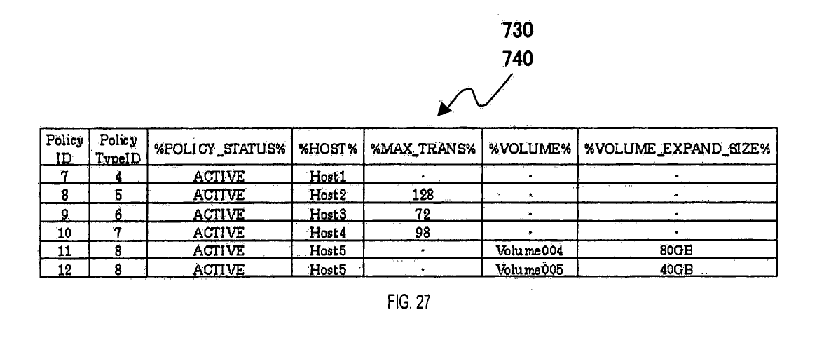

The policy definition 730 specifies the value of a parameter defined by the policy type definition 720 as the contents of a policy. FIG. 27 shows a policy definition 730 according to the second embodiment. The policy definition 730 according to the second embodiment comprises a “Policy ID” field, a “Policy Type ID” field, a “% POLICY_STATUS %” field, a “% HOST %” field, a “% MAX_TRANS %” field, a “% VOLUME %” field, and a “% VOLUME_EXPAND_SIZE %” field. The “Policy ID” field and “Policy Type ID” field defines a policy and a policy type, respectively. The “% POLICY_STATUS %” field defines whether a policy is executable. When the policy is “ACTIVE”, it is executable. When the policy is “SUSPEND”, it is unexecutable. The execution of a specific policy can be limited by setting its % POLICY_STATUS % to “SUSPEND”. The “% HOST %” field, “% MAX_TRANS %” field, “% VOLUME %” field, and “% VOLUME_EXPAND_SIZE %” field indicate the name of an execution host, the maximum number of transactions, the available volume capacity, and the size of volume expansion unit, respectively. The parameters for the above four fields vary with the contents of policy type definition. Therefore, the contents of the fields of the policy definition 730 also vary with a change in the contents of policy type definition.

As tuning examples according to the second embodiment, the tuning processing operations for tuning IDs 3, 4, and 5 in the tuning definition 760 shown in FIG. 22 will now be described in detail. The processing operations for tuning IDs 1 and 2 in the tuning definition 760 are detailed in conjunction with the first embodiment and will not be described again.

In tuning ID 3 according to the second embodiment, the job-executing host is determined in accordance with the loads on the hosts. The definition for “Tuning ID 3” in FIG. 22 states that tuning is executed for global policy IDs 5 and 6 (refer to the “Target Global Policy ID” field) at 2:00 a.m. everyday (refer to the “Tuning Timing Details” field). When the specified time (2:00 a.m.) arrives, the policy management program 300 starts a tuning process. When calculating the degree of conformance, the policy management program 300 references the global policy definition 710, tuning parameter definition 750, policy type definition 720, policy definition 730, and resource definition 820 and calculates the degree of conformance in accordance with the weight.

The global policy definition 710 shown in FIG. 24 states that the host's CPU usage percent should be not higher than 50%, and that Host 1 should not be designated for a specific period of time (Jun. 11, 2003 to Jun. 13, 2003). Although subnet A is designated in a conditional expression for global policy ID 5, it can be omitted because it is specified in the tuning parameter definition 750.

As regards a tuning parameter, the tuning parameter definition shown in FIG. 23 indicates that % HOST % is targeted, and that a host existing within subnet A is targeted. As shown in FIG. 22, policy type 4 is a target for tuning ID 3. The policy type definition shown in FIG. 25 states that an arbitrary business host (% HOST %) executes a job (batch b).

The policy definition shown in FIG. 27 states that policy targeted for tuning is policy ID 7. For degree-of-conformance calculation for global policy ID 5, the host's CPU usage percent (% CPU_USAGE %) is acquired from the resource definition 820. For global policy ID 6, the current time is acquired and compared against a conditional expression.

After termination of tuning, an event corresponding to policy type ID 4, which is specified by the policy execution timing definition 770 shown in FIG. 26, is issued. Therefore, policy ID 7, which belongs to policy type ID 4, is executed. When the completion of tuning is defined as an event in this manner, a policy that is appropriately set after tuning can be executed. Further, when a tuning execution itself is registered as a schedule, job execution can be initiated by an appropriate host in accordance with the registered schedule (while there is more than one set of requirements).

Tuning ID 4 according to the second embodiment adjusts the settings for a plurality of servers. Since the basic procedure and reference table are the same as those for tuning ID 3, some portions will not be described again.

In the event of http request rejection (refer to the tuning timing details), tuning ID 4 performs a tuning process for global policies ID 7, 8, and 9 as indicated in FIG. 22. The conditions specified by global policy ID 7 state that the Web server processing transaction count should not exceed a selected upper-limit value. The conditions specified by global policy ID 8 state that the upper-limit value selected for the AP server processing transaction count should always be smaller than the upper-limit value selected for the Web server processing transaction count.

The conditions specified by global policy ID 9 state that the upper-limit value selected for the DB server processing transaction count should always be smaller than the upper-limit value selected for the AP server processing transaction count. The conditions specified by global policies ID 8 and 9 also state that the hosts belong to the same service group. As a tuning parameter, the upper-limit value for the processing transaction count (% MAX_TRANS %) is specified. A search is conducted with reference to the default value (128). Since % MAX_TRANS%, % SERVICE_GROUP%, and the like are required for global policy conditional judgment, the relevant information is derived from the resource definition 820 for degree-of-conformance calculation purposes. Here, it is obvious that hosts 2, 3, and 4 belong to the same service group. The policies targeted for tuning are policies ID 8, 9, and 10. Policy execution starts upon completion of tuning as is the case with tuning ID 3. As described above, it is possible to adjust the settings for a plurality of servers.

Tuning ID 5 according to the second embodiment specifies the capacity to be added in accordance with the remaining volume capacity. The second embodiment assumes a process in which a volume pool is used to dynamically add a capacity when the remaining capacity of the previously allocated volume is small. Since the basic procedure and reference table are the same as those for tuning ID 3, some portions will not be described again.

Turning back to FIG. 22, tuning ID 5 defines that a tuning process is to be performed for global policies ID 10 and 11 at 3:00 a.m. everyday. Tuning ID 5 also defines that the volume expansion increments for global policy ID 10 must be not greater than 1/10 the remaining volume capacity when the remaining volume capacity is smaller than 30%, and that the policy execution status for global policy ID 11 must be SUSPEND when the remaining volume capacity is smaller than 10%. Policies ID 11 and 12 correspond to global policy ID 11. Therefore, policies ID 11 and 12 will not be executed when the remaining volume capacity is smaller than 10%. In the example shown in FIG. 22, the remaining volume capacity is checked once each day. If the remaining volume capacity is small, it is possible to determine whether to decrease the expansion size accordingly or disable the volume expansion feature, and execute accordingly.

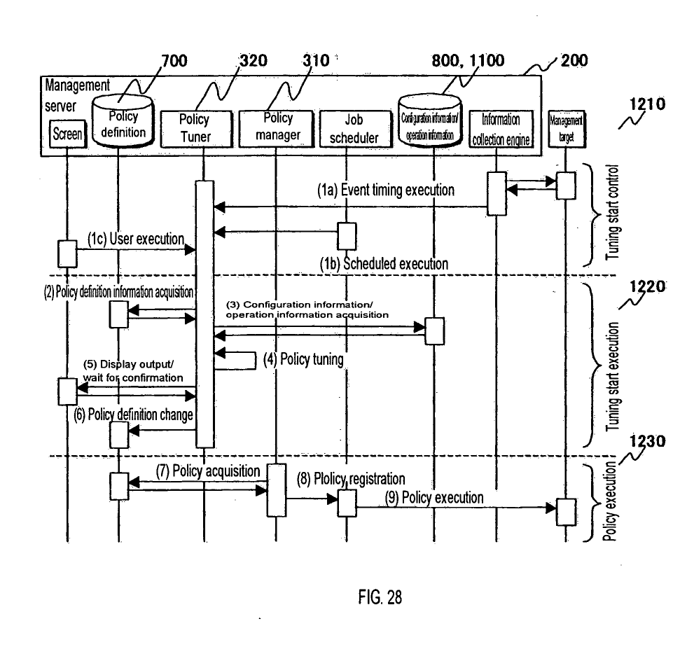

The processing sequence according to the second embodiment will now be described. The following description is also applicable to the first embodiment. FIG. 28 shows a tuning processing sequence according to the second embodiment.

The policy management program 300 comprises a policy tuner 320 and a policy manager 310. The job scheduler is a program that provides job schedule management and execution control. It can be defined as one function of the policy management program 300.

The policy manager 310 registers a policy as a job in relation to the job scheduler. The policy tuner 320 exercises a tuning function. As described earlier, there are three modes of tuning start control 1210: (1a) starting execution when an event occurs, (1b) starting execution in accordance with a schedule, and (1c) allowing the user to start execution. In mode (1a) in which execution starts when an event occurs, the information collection engine 209 acquires operation performance information from a management target and notifies the policy tuner of a specific event. In other words, the information collection engine instructs the policy tuner to start tuning execution.

In tuning execution 1220, the instruction for tuning execution is received from the tuning start control 1210 to check whether the parameter value for the associated policy conforms to the global policy ID. For example, the information is derived from the policy definition 700 to obtain configuration definition/operation performance information and then initiate tuning execution. The results of tuning are output to the display or the like. If necessary, the policy definition is changed upon administrator verification.

In policy execution 1230, the policy manager 310 registers a policy in relation to the job scheduler. When a policy is to be executed when a tuning completion event occurs, all processes ranging from tuning to policy change and execution can be sequentially completed.

What is claimed is:

1. A computer-readable medium containing a computer software program for causing a computer to perform the steps of:
allowing an information processing device included in an information processing system to receive a parameter entered for setting policies in which processes to be performed in said information processing system are defined; and
changing said parameter for said policies so that a policy set, which is an aggregate of policies set by said parameter, better matches the control strategy of said information processing system.

2. A computer-readable medium according to claim 1, wherein said information processing system including said information processing device comprises a storage device for storing data, a backup device for saving a duplicate of data stored in said storage device, a computer for accessing said storage device, and a network device for interconnecting said information processing device, said storage device, said backup device, and said computer; and wherein said policy set is an aggregate of said policies for defining processes to be performed by said storage device, said computer, said backup device, or said network device.

3. A computer-readable medium according to claim 2, wherein said processes to be performed by said information processing system defined by said policies include any one of a process for saving a duplicate of data stored in a storage area possessed by said storage device specified by said parameter into said backup device specified by said parameter at a time specified by said parameter, a process for causing said computer specified by said parameter to perform a batch process using data stored in said storage area possessed by said storage device specified by said parameter at a time specified by said parameter, and a process for allocating a user specified by said parameter said storage area having a storage capacity specified by said parameter, which is within said storage area possessed by said storage device specified by said parameter.

4. A computer-readable medium according to claim 3, wherein the control strategy of said information processing system includes any one of a provision stipulating that a plurality of said policies controlling the same said backup device be not allowed to exist during the same period of time, a provision stipulating that a plurality of said policies controlling the same said storage device be not allowed to exist during the same period of time, a provision stipulating that a process for saving a duplicate of data stored in said storage area possessed by said storage device into said backup device start at a specified time, and a provision stipulating that said storage area that is possessed by said storage device and allocated to said user be recognized as a storage area allocatable to said user.

5. A computer-readable medium according to claim 1, wherein said step for changing said parameter for said policies so that a policy set, which is an aggregate of said policies set by said parameter, better matches the control strategy of said information processing system calculates the degree-of-nonconformance value, which is a numerical value representing the degree of nonconformance of said policy set to the control strategy of said information processing system, and changes said parameter so as to decrease said degree-of-nonconformance value.

6. A computer-readable medium according to claim 5, wherein said degree-of-nonconformance value is calculated by multiplying the coefficient setting for a control strategy of said information processing system by the number of policy combinations nonconforming to the control strategy of the information processing system and adding up the resulting values for all control strategies of said information processing system.

7. A computer-readable medium according to claim 1, wherein said step for receiving a parameter entered for setting policies in which processes to be performed in said information processing system are defined receives an input for specifying said policies for which said parameter is not to be changed; and wherein said step for changing said parameter for said policies so that a policy set, which is an aggregate of said policies set by said parameter, better matches the control strategy of said information processing system changes said parameter for said policies other than said policies specified so that said policy set better matches the control strategy of said information processing system.

8. An information processing device included in an information processing system, comprising:
an input receiver for receiving a parameter entered for setting policies in which processes to be performed in said information processing system are defined; and
a parameter changer for changing said parameter for said policies so that a policy set, which is an aggregate of said policies set by said parameter, better matches the control strategy of said information processing system.

9. An information processing device according to claim 8, wherein said information processing system comprises a storage device for storing data, a backup device for saving a duplicate of data stored in said storage device, a computer for accessing said storage device, and a network device for interconnecting said information processing device, said storage device, said backup device, and said computer; and wherein said policy set is an aggregate of said policies for defining processes to be performed by said storage device, said computer, said backup device, or said network device.

10. An information processing device according to claim 9, wherein the processes to be performed by said information processing system defined by said policies include a process for saving a duplicate of data stored in a storage area possessed by said storage device specified by said parameter into said backup device specified by said parameter at a time specified by said parameter, a process for causing said computer specified by said parameter to perform a batch process using data stored in said storage area possessed by said storage device specified by said parameter at a time specified by said parameter, or a process for allocating a user specified by said parameter said storage area having a storage capacity specified by said parameter, which is within said storage area possessed by said storage device specified by said parameter.

11. An information processing device according to claim 10, wherein the control strategy of said information processing system includes any one of a provision stipulating that a plurality of said policies controlling the same said backup device be not allowed to exist during the same period of time, a provision stipulating that a plurality of said policies controlling the same said storage device be not allowed to exist during the same period of time, a provision stipulating that a process for saving a duplicate of data stored in said storage area possessed by said storage device into said backup device start at a specified time, and a provision stipulating that said storage area that is possessed by said storage device and allocated to said user be recognized as a storage area allocatable to said user.

12. An information processing device according to claim 8, wherein said parameter changer calculates a degree-of-nonconformance value, which is a numerical value representing the degree of nonconformance of said policy set to the control strategy of said information processing system, and changes said parameter so as to decrease said degree-of-nonconformance value.

13. An information processing device according to claim 12, wherein said degree-of-nonconformance value is calculated by multiplying the coefficient setting for a control strategy of said information processing system by the number of policy combinations nonconforming to the control strategy of the information processing system and adding up the resulting values for all control strategies of said information processing system.

14. An information processing device according to claim 8, wherein said input receiver receives an input for specifying said policies for which said parameter is not to be changed; and wherein said parameter changer changes said parameter for said policies other than said policies specified so that said policy set better matches the control strategy of said information processing system.

15. A method for controlling an information processing device included in an information processing system, the method comprising the steps of:
causing said information processing device to receive a parameter entered for setting policies in which processes to be performed in said information processing system are defined; and
causing said information processing device to change said parameter for said policies so that a policy set, which is an aggregate of said policies set by said parameter, better matches the control strategy of said information processing system.

16. A computer-readable medium according to claim 2, wherein the step for changing said parameter changes said parameter so as to better match the control strategy of said information processing system while using the operation performance information on at least one of said storage device, said backup device, said computer, and said network device, which are included in said information processing system.

17. A computer-readable medium according to claim 1, wherein the step for receiving an input specifying said control strategy and the step for changing said parameter change said parameter so as to match said specified control strategy.

18. An information processing device according to claim 8, further comprising an acquisition section for acquiring the operation performance information on at least one of said storage device, said backup device, said computer, and said network device, which are included in said information processing system, wherein said parameter changer uses said acquired operation performance information.

19. The information processing device according to claim 8, wherein said input receiver receives an input for specifying the control strategy of said information processing system to be applied, and wherein said parameter changer changes a parameter for said policies to make said policies match said specified control strategy.

20. The information processing device according to claim 19, further comprising an execution instruction section for issuing instructions for the processing of said parameter changer, wherein said parameter changer is processed in compliance with said instructions.
